(19) United States
(12) Patent Application Publication
(10) Pub. No.: US 2017/0151661 A1
(43) Pub. Date: Jun. 1, 2017

(54) TRIGGER MECHANISM FOR POWER TOOL

(71) Applicant: TRANMAX MACHINERY CO., LTD., TAICHUNG CITY (TW)

(72) Inventor: HSIN-CHI CHEN, TAICHUNG CITY (TW)

(21) Appl. No.: 15/040,371

(22) Filed: Feb. 10, 2016

(30) Foreign Application Priority Data
Nov. 26, 2015 (TW) 104139389

(51) Int. Cl. B25F 5/02; H01H 13/14; H01H 13/08

(52) U.S. Cl. CPC B25F 5/02; H01H 13/08; H01H 13/14

(57) ABSTRACT

A trigger mechanism used in a power tool is disclosed to include a grip including a mounting chamber and two opposing first guide portions, and a tripper, which is mounted in the mounting chamber of the grip and movable by an external force along an axis direction relative to the grip and includes two opposing second guide portions respectively coupled to the first guide portions of the grip for enabling the trigger to move moved along the axis direction relative to the grip in a stable and smooth manner.

### BACKGROUND OF THE INVENTION

1. Field of the Invention

The present invention relates to power tool technology, and more particularly to a trigger mechanism for power tool.

2. Description of the Related Art

The operation of a conventional power tool is to press the trigger, driving the internal power drive (such as motor) to provide power output for rotating the tool bit so that the tool bit can rotate a screw or achieve other works.

In the operation of the trigger of a power tool, when is pressed by an external force, it is moved toward the inside of the power tool. Once the applied force disappears, the trigger will be immediately returned to its former position by the elastic restoring energy of an elastic return member. However, in the aforesaid prior art technique, the trigger can get stuck easily during operation due to an installation problem, wear damage of structural components or other factors, likely causing the problem of being unable to accurately start or to immediately shut down and bringing trouble in operation.

### SUMMARY OF THE INVENTION

The present invention has been accomplished under the circumstances in view. It is the main object of the present invention to provide a trigger mechanism for power tool, which enables the trigger to be operated stably and smoothly, increasing the ease of operation.

To achieve this and other objects of the present invention, a trigger mechanism comprises a grip, a trigger and an elastic member. The grip comprises a mounting chamber, and two first guide portions located at an inside wall of the mounting chamber at two opposite sides. The trigger is mounted in the mounting chamber of the grip and pressable by an external force to move along an axis direction relative to the grip. The trigger comprises two second guide portions disposed at opposing left and right sides relative to the axis direction and respectively slidably coupled to the first guide portions of the grip. The elastic member is mounted in the mounting chamber of the grip and stopped against the trigger for moving the trigger in the reverse direction relative to the axis direction so that the trigger can be maintained in an unpressed position after the external force disappeared. Subject to coupling between the first guide portions and the second guide portions, the operating smoothness of the trigger is enhanced.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an elevational view of a power tool using a trigger mechanism in accordance with the present invention.

FIG. 2 is an exploded view of the trigger mechanism in accordance with the present invention.

FIG. 3 is a sectional side view of the present invention, illustrating a status of the trigger before pressing.

FIG. 4 is a sectional view taken along line 4-4 of FIG. 3.

FIG. 5 is similar to FIG. 3, illustrating the trigger pressed.

FIG. 6 is a sectional view taken along line 6-7 of FIG. 5.

### DETAILED DESCRIPTION OF THE INVENTION

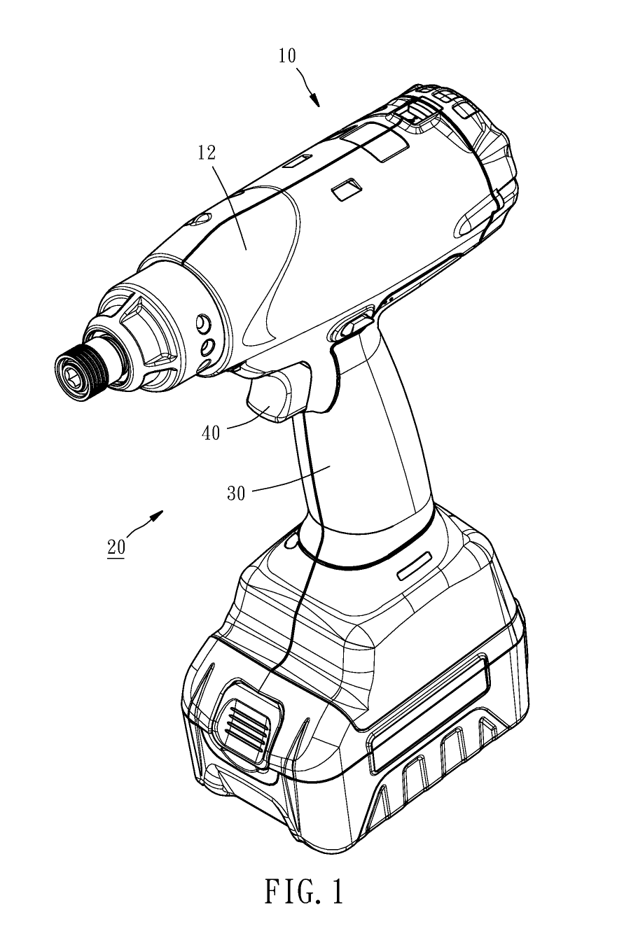

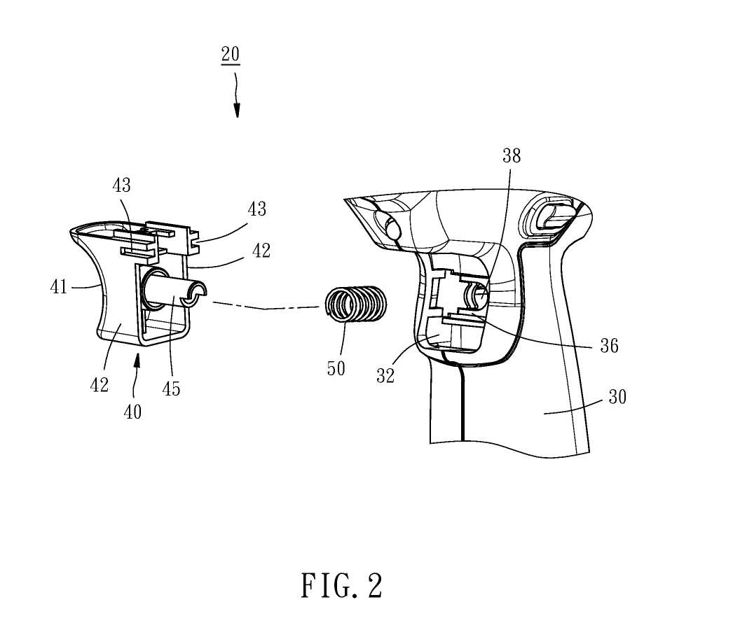

Referring to FIG. 1, a trigger mechanism 20 in accordance with the present invention is shown used in a power tool 10, which comprises a housing 12, and a power drive (not shown) mounted in the housing ‘12. As the power tool 10 is of the known art and in order to save space, no further description on the structural details and operating principle of the power tool 10 will be necessary. Please refer also to FIG. 2, the trigger mechanism 20 of the present invention comprises a grip 30, a trigger 40, and an elastic member 50.

The grip 30 is connected to a bottom side of the housing 12, comprising a mounting chamber 32, two first guide portions 34 located on an inside wall of the mounting chamber 32 at two opposite sides, a baffle plate 36 spaced between the two first guide portions 34, and a through hole 38 cut through the baffle plate 36. In this embodiment, the first guide portions 34 are elongated protruding blocks protruded from the inside wall of the mounting chamber 32.

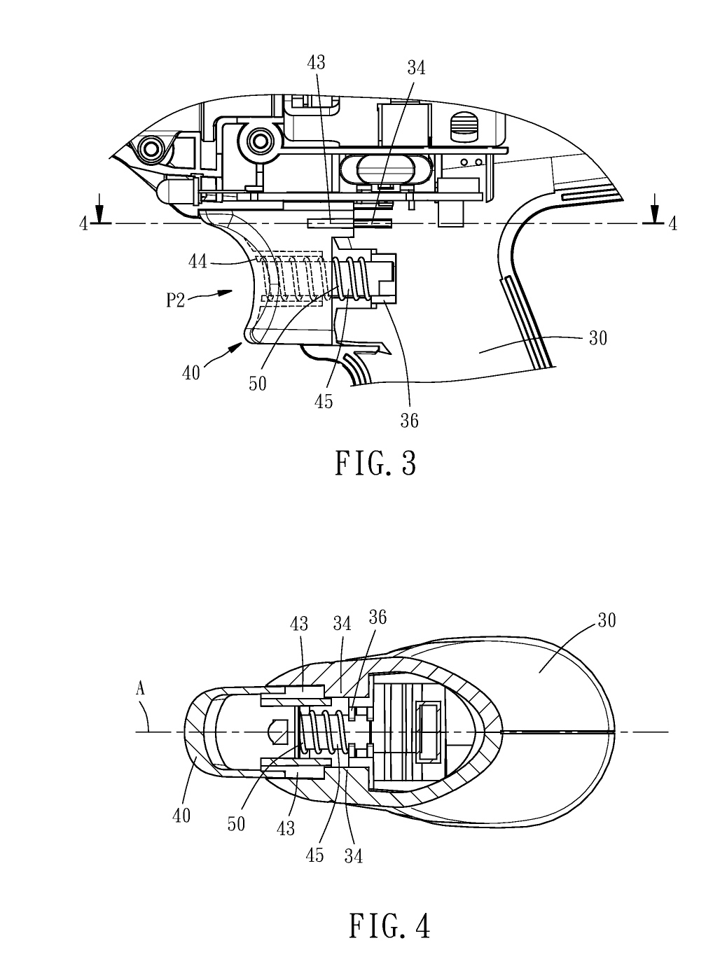

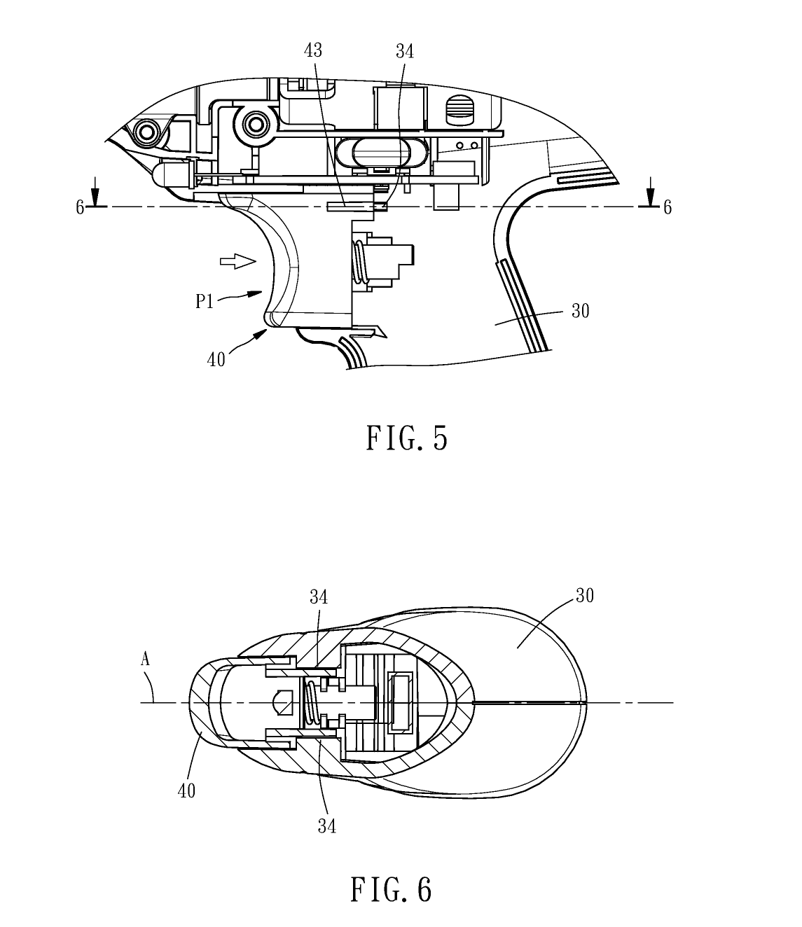

The trigger 40 is mounted in the mounting chamber 32 of the grip 30, comprising a pressing panel 41, two side panels 42 respectively connected to the pressing panel 41 at opposing left and right sides, and a second guide portion 43 located at an outer side of each side panel 42. The two second guide portions 43 are disposed at opposing left and right sides in a symmetrical manner relative to an axis direction A (see FIG. 4), i.e., the two second guide portions 43 are disposed in the same horizontal position and the extending direction of the two second guide portions 43 is in parallel to the axis direction A. In this embodiment, the second guide portions 43 are elongated grooves fitting the elongated protruding blocks of the first guide portions 34. By means of respectively coupling the second guide portions 43 to the first guide portions 34, the trigger 40 can be moved by an external force along the axis direction A relative to the grip 30 to a pressed position P1 (see FIG. 5 and FIG. 6), controlling the power drive to output power. Further, as shown in FIG. 3 and FIG. 4, the trigger 40 further comprises a bearing wall 44 and an axle 45. The bearing wall 44 is located at an inner side of the pressing panel 41. The axle 45 extends from the bearing wall 44 along the axis direction A toward the baffle plate 36 of the grip 30 at an elevation lower than the second guide portions 43 and inserts with the end thereof into the through hole 38 in the baffle plate 36.

The elastic member 50 is mounted in the mounting chamber 32 of the grip 30 and sleeved onto the axle 45 of the trigger 40 with two opposite ends thereof respectively stopped against the baffle plate 36 of the grip 30 and the bearing wall 44 of the trigger 40 to push the trigger 40 in the reverse direction relative to the axis direction A so that the trigger 40 can be maintained in an unpressed position P2 (see FIG. 3 and FIG. 4) after the external force disappeared.

Viewed from above, we can know that by means of coupling between the symmetrical second guide portions 43 of the trigger 40 and the first guide portions 34 of the grip 30, the trigger mechanism 20 enables the trigger 40 to be supported in a balanced manner on the same horizontal level and moved stably and smoothly along the two symmetrical second guide portions 43 without being biased toward one lateral side, and thus, the design of the trigger mechanism 20 greatly enhances operating convenience.

What is claimed is:

1. A trigger mechanism for power tool, comprising:
a grip comprising a mounting chamber and two first guide portions located at an inside wall of said mounting chamber at two opposite sides;
a trigger mounted in said mounting chamber of said grip and pressable by an external force to move along an axis direction relative to said grip, said trigger comprising two second guide portions disposed at opposing left and right sides relative to said axis direction and respectively slidably coupled to said first guide portions of said grip; and
an elastic member mounted in said mounting chamber of said grip and stopped against said trigger for moving said trigger in the reverse direction relative to said axis direction.

2. The trigger mechanism as claimed in claim 1, wherein the extending direction of said second guide portions of said trigger in parallel to said axis direction.

3. The trigger mechanism as claimed in claim 2, wherein said grip further comprises a baffle plate, and a through hole cut through said baffle plate; said trigger further comprises a bearing wall and an axle, said axle being extended from said bearing wall along said axis direction toward said baffle plate of said grip with a distal end thereof inserted into said through hole; said elastic member is sleeved onto said axle of said trigger, having two opposite ends thereof respectively stopped against said baffle plate of said grip and said bearing wall of said trigger.

4. The trigger mechanism as claimed in claim 3, wherein said axle of said trigger is disposed at an elevation lower than said second guide portions of said trigger.

5. The trigger mechanism as claimed in claim 1, wherein said trigger further comprises a pressing panel and two side panels connected to said pressing panel at opposing left and right sides; said two second guide portions are respectively located at said side panels at an outer side.

6. The trigger mechanism as claimed in claim 1, wherein said first guide portions are protruding blocks; said second guide portions are grooves.
